(19) United States
(12) Patent Application Publication
(10) Pub. No.: US 2014/0301401 A1
(43) Pub. Date: Oct. 9, 2014

(54) PROVIDING AGGREGATION LINK GROUPS IN LOGICAL NETWORK DEVICE

(71) Applicant: Hangzhou H3C Technologies Co., Ltd., Hangzhou (CN)

(72) Inventors: Hongyuan Wang, Beijing (CN); Guoliang Zheng, Beijing (CN)

(73) Assignee: Hangzhou H3C Technologies Co., Ltd., Hangzhou (CN)

(21) Appl. No.: 14/210,420

(22) Filed: Mar. 13, 2014

(30) Foreign Application Priority Data
Apr. 7, 2013 (CN) 201310117323.4

(51) Int. Cl. H04L 12/931; H04L 12/46; H04L 29/12

(52) U.S. Cl. CPC H04L 49/70; H04L 61/10; H04L 12/4641
USPC 370/395.53; 370/409

(57) ABSTRACT

A control plane of a logical network device creates a service link aggregation group and adds one port from each member network device to the service link aggregation group. The logical network device includes member network devices and each port connects the logical network device to the same neighbor device. When a port of the logical network device receives a message with an unknown source address, the control plane determines if the receiving port is in any service link aggregation group. After determining the receiving port is in the service link aggregation group, the control plane configures a data plane of the logical network device with mappings between the address and the ports in the service link aggregation group.

### CROSS-REFERENCE TO RELATED APPLICATIONS

This application claims priority to CN Patent Application No. 201310117323.4, filed on Apr. 7, 2013, entitled “Method and Device for Processing Aggregation in IRF System,” which is incorporated herein by reference.

### BACKGROUND

Virtualization technology, such as intelligent resilient framework (IRF) and virtual switching system (VSS), allows multiple network devices to be combined into a logical network device after necessary configurations. The resulting logical network device offers streamlined management, high reliability, and powerful network expansion capability.

### BRIEF DESCRIPTION OF THE DRAWINGS

In the drawings:

FIG. 1 is a block diagram illustrating a system with a logical network device with service link aggregation groups in examples of the present disclosure;

FIG. 2 is a block diagram of the system of FIG. 1 where a port in a service link aggregation group is down in examples of the present disclosure;

FIG. 3 is a flowchart of a method for a control plane in a member device in the logical network device of FIG. 1 to create service link aggregation groups in examples of the present disclosure;

FIG. 4 is a flowchart of a method for a control plane in a member device in the logical network device of FIG. 1 to configure data planes of member devices in the logical network device in examples of the present disclosure;

FIG. 5 is a flowchart of a method for a control plane in a member device in the logical network device of FIG. 1 to update the data planes of the member devices in the logical network device when ports go down in examples of the present disclosure;

FIG. 6 is a flowchart of a method for a control plane of a member device in logical network device of FIG. 1 to update the data planes of the member devices in the logical network device when ports recover in examples of the present disclosure;

FIG. 7 is a member device to provide service link aggregation groups in examples of the present disclosure; and

FIG. 8 is a block diagram of a computing device to implement a control plane in the member device of FIG. 7 in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on. The term “or” is used to refer to a nonexclusive such that “A or B” includes “A but not B,” “B but not A,” and “A and B” unless otherwise indicated.

Multiple physical network devices (e.g., switches or routers) may be virtualized to form one logical network device. In the logical network device, physical ports on different member devices may be connected to the same neighbor device (e.g., a server) and combined to form an aggregated port, which is then connected by an aggregated link to an aggregated port on the neighbor device. Such cross-device aggregation increases bandwidth and provides redundancy.

To implement cross-device aggregation, the control plane of a member device creates a link aggregation group (LAG) on the data plane of each member device, adds the physical ports connected to the same neighbor device to the LAG, and enables local-first load sharing for the LAG. When local-first load sharing is enabled, the data plane of each member device distributes traffic preferentially to a member port of the LAG local to the data plane rather than all the member ports of the LAG in order to reduce traffic between member devices.

When the control plane of the logical network device learns a new address (e.g., a media access control (MAC) address) from one of the member ports of the LAG, the control plane records the mapping between the address and the LAG ID in the data plane of each member device. When the data plane of a member device receives a packet destined for the same address, it looks up the address, finds the corresponding LAG ID, and performs hashing based at least partly on the LAG ID to select a member port of the LAG to forward the packet. As local-first load sharing is enabled, the data plane preferentially sends the packet from a local member port of the LAG. However if the link between the local member port and the neighbor device fails, the data plane sends the packet to another member device to forward the packet to its destination.

As described above, mappings between addresses and LAG IDs are recorded in the data plane of each member device in a logical network device. In actual network applications, each member device may have more than 1,000 physical ports that are each to be connected to a distinct neighbor device and added to a district LAG for cross-device aggregation. However, data plane hardware of each member device may support a smaller number of LAGs (e.g., 512 to 1,000 LAGs). Thus what are needed are method and apparatus to provide a greater number of cross-device aggregation groups that is not limited by data plane hardware in network devices.

In examples of the present disclosure, a control plane in a logical network device creates a new type of link aggregation group referred to as a “service link aggregation group.” Similar to the LAG previously described, the service link aggregation group includes one port from each member device and all member ports in the service link aggregation group are connected to the same neighbor device. Unlike the LAG previously described, the control plane creates the service link aggregation group at the control plane but not in the data plane of each member device in the logical network device.

When the control plane learns new a new address from one of the member ports, the control plane records a different mapping in each data plane of the member devices. For each data plane, the control plane records a mapping between the address and a local member port on the data plane instead of a link aggregation group ID. Thus the number of service ink aggregate groups is not limited by data plane hardware as the service link aggregation groups are not LAGs created at the data planes and the data planes do not use LAG IDs to determine hashing to forward packets.

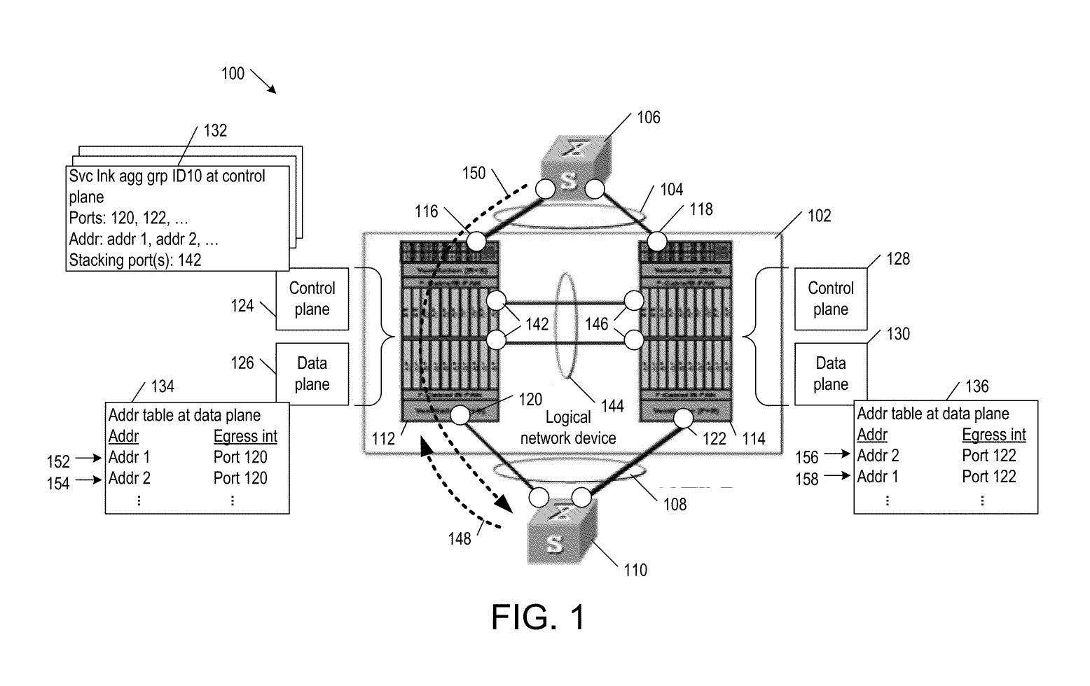

FIG. 1 is a block diagram illustrating a system 100 with a logical network device 102 having an aggregated uplink 104 to an upstream neighbor device 106 and an aggregated downlink 108 to a downstream neighbor device 110 in examples of the present disclosure. Logical network device 102 is virtualized from physical network devices 112 and 114 using a technology such as intelligent resilient framework (IRF). Member device 112 has physical stacking ports that form an aggregated stacking port 142 connected by an aggregated stacking link 144 to an aggregated stacking port 146 formed from physical stacking ports on member device 114. Although only member devices 112 and 114 are shown, logical network device 102 may include more than two member devices. Although one aggregated uplink 104 and one aggregated downlink 106 are shown, logical network device 102 may include more than one aggregated uplink and more than one aggregated downlink.

Member devices 112 and 114 have respective uplink ports 116 and 118 connected to ports on neighbor device 106, and respective downlink ports 120 and 122 connected to ports on neighbor device 110. Member device 112 has a control plane 124 and a data plane 126. Control plane 124 may be a device or a control board with a central processing unit (CPU) system (e.g., processor and memories) and a stacking module. Data plane 126 may be a device or a switch fabric board with a CPU system and a switching chip. Similarly member device 114 has a control plane 128 and a data plane 130.

Member device 112 may be the master device in logical network device 102 so its control plane 124 serves as the control plane of logical network device 102. Member device 114 may be the slave device in logical network device 102 so its control plane 128 serves as a backup to control plane 124. Control plane 124 configures the forwarding functions in data planes 126 and 130 of respective member devices 112 and 114.

In examples of the present disclosure, control plane 124 creates a service link aggregation group 132 on the control plane itself. Service link aggregation group 132 includes one port from each member device and all ports in service link aggregation group 132 are connected to the same neighbor device. For example, service link aggregation group 132 includes ports 120 and 122 connected to neighbor device 110.

When control plane 124 learns a new address associated with a port in logical network device 102, control plane 124 determines if the port is a member of a service link aggregation group. For example, control plane 124 learns address 1 from port 120 and then determines if port 120 is a member of a service link aggregation group. Similarly control plane 124 learns address 2 from port 122 and then determines if port 122 is a member of a service link aggregation group.

When the port is a member of a service link aggregation group, control plane 124 records mappings between the address and the member ports in the data planes of the member devices. Control plane 124 records a different mapping in each member device's data plane. For each data plane, control plane 124 records a mapping between the address and a local member port on the data plane. For example, when control plane 124 learns address 1 from port 120, control plane 124 records a mapping 152 of the relationship between address 1 and port 120 in an address table 134 of data plane 126, and a mapping 158 of the relationship between address 1 and local port 122 in an address table 136 of data plane 130. Similarly, when control plane 124 learns address 2 from port 122, control plane 124 records a mapping 154 of the relationship between address 2 and port 120 in address table 134, and a mapping 156 of the relationship between address 2 and port 122 in address table 136.

When a data plane receives a packet destined for an address, the data plane looks for an egress interface for the address in its address table. For example, when data plane 126 receives a packet destined for address 1, data plane 126 looks for a corresponding egress interface for address 1 in its address table 134. When the data plane finds the corresponding egress interface in its address table, the data plane forwards the packet through the egress interface. For example, data plane 126 finds the corresponding egress interface of port 120 for address 1 in its address table 134 and forwards the packet through port 120.

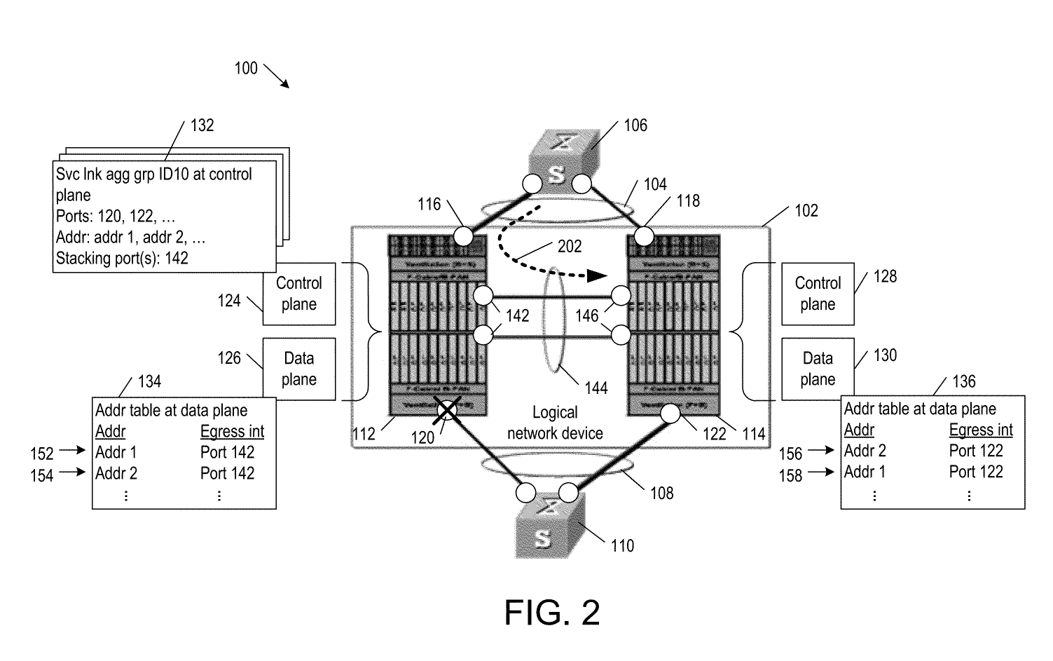

When control plane 124 learns a port has gone down in logical network device 102, control plane 124 determines if the port is a member of a service link aggregation group. For example, referring to FIG. 2, control plane 124 learns port 120 has gone down and determines if port 120 is a member of a service link aggregation group. A port may be down because of a port failure or a link failure.

When the port is a member of a service link aggregation group, control plane 124 updates mapping(s) for the down port so packets destined for address(es) learned from the port(s) in the service link aggregation group are forwarded through a stacking port to another member device. When a data plane has multiple stacking ports, control plane 124 may select one of the stacking ports based on a predetermined selection strategy. For example, when port 120 changes to the link down state, control plane 124 updates mappings 152 and 154 for port 120 to change the egress interface from port 120 to stacking port 142. This causes packets destined for address 1 to be forwarded to member device 114, which forwards the packet based on its forwarding table 136.

When control plane 124 learns a port in logical network device 102 has recovered, control plane 124 determines if the port is a member of a service link aggregation group. For example, control plane 124 detects port 120 has recovered and determines if port 120 is a member of a service link aggregation group.

When the recovered port is a member of a service link aggregation group, control plane 124 updates the mapping(s) for the recovered port so packets destined for the address(es) learned from the port(s) in the service link aggregation group are again forward through the member port instead of a stacking port. For example, when port 120 recovers to the link up state, control plane 124 updates mappings 152 and 154 for port 120 to change the egress interface from stacking port 142 to port 120.

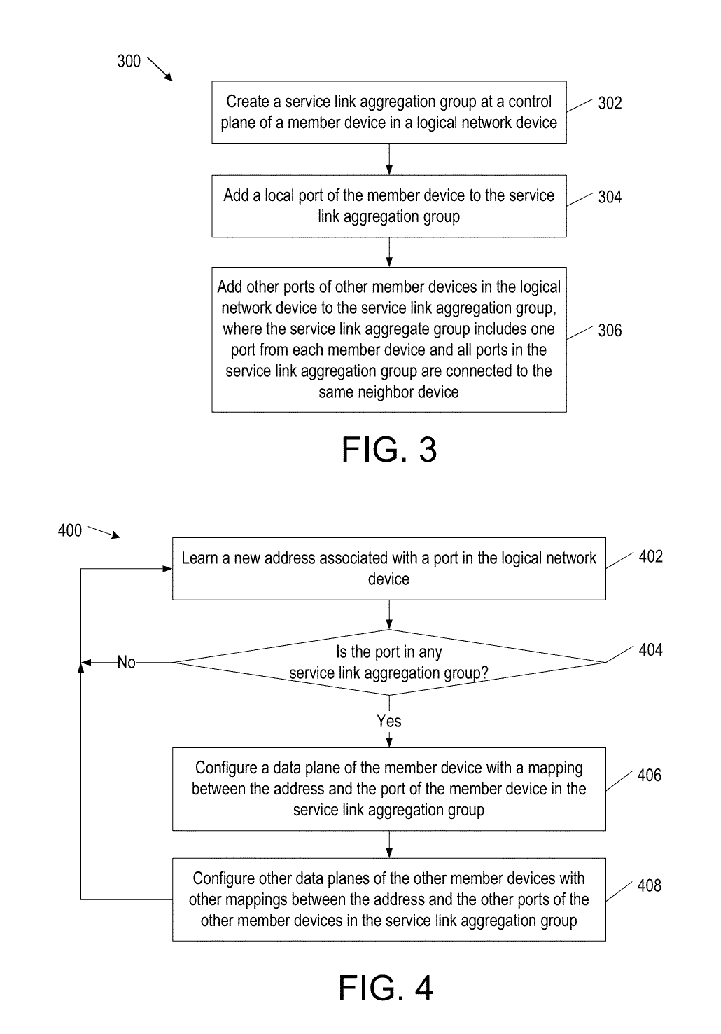

FIG. 3 is a flowchart of a method 300 for a control plane of a member device in logical network device 102 (FIG. 1) to create service link aggregation groups in examples of the present disclosure. Method 300 may be performed by a control plane of a master device in logical network device 102. For example, method 300 may be performed by a processor in the CPU system of the control plane. Method 300 may begin in block 302.

In block 302, the control plane creates a service link aggregation group at the control plane itself but not at the data planes of logical network device 102. In other words, the control plane creates, saves, and manages a data structure for the service link aggregation group with control plane software or hardware but not with data plane software or hardware. The data structure for the service link aggregation group may identify member ports and addresses learned from the member ports. A member port may be identified as a specific port on a member device. For example, control plane 124 (FIG. 1) creates service link aggregation group 132 (FIG. 1). Block 302 may be followed by block 304.

In block 304, the control plane adds a local port from its member device to the service link aggregation group. For example, control plane 124 adds port 120 (FIG. 1) to service link aggregation group 132. Block 304 may be followed by block 306.

In block 306, the control plane adds other port(s) from other member device(s) to the service link aggregation group. Thus the service link aggregation group includes one port from each member device and all the ports in the service link aggregation group are connected to the same neighbor device. For example, control plane 124 adds port 122 (FIG. 1) to service link aggregation group 132. Method 300 may end at block 306 or block 306 may be followed by block 302 to create another service link aggregation group.

FIG. 4 is a flowchart of a method 400 for a control plane of a member device in logical network device 102 (FIG. 1) to configure data planes of member devices in logical network device 102 in examples of the present disclosure. Method 400 may be performed by a control plane of a master device in logical network device 102. For example, method 400 may be performed by a processor in the CPU system on the control plane. Method 400 may begin in block 402.

In block 402, the control plane learns a new address associated with a port in logical network device 102. The control plane may learn a new address associated with a port when a packet with an unknown source address arrives at the port of a data plane on a member device and the data plane provides the port and the address to the control plane. The packet may be a layer 2 packet or a layer 3 packet. For example, control plane 124 (FIG. 1) learns address 1 (FIG. 1) from port 120 (FIG. 1) when a packet 148 with an unknown source address 1 arrives at port 120 of data plane 126 and data plane 126 provides the port and the address to control plane 124. Similarly control plane 124 learns address 2 (FIG. 1) from port 122 (FIG. 1). Block 402 may be followed by block 404.

In block 404, the control plane determines if the port is a member of any service link aggregation group. To do so, the control plane searches for the port in service link aggregation groups. If the control plane finds the port in a service link aggregation group, block 404 may be followed by block 406. Otherwise method 400 may end or block 404 may be followed by block 402 to process the next new address. For example, control plane 124 finds port 120 (FIG. 1) in service link aggregation group 132 (FIG. 1).

In block 406, the control plane configures the local data plane of the member device with a mapping between the address and the port of the member device in the service link aggregation group. For example, control plane 124 records a mapping 152 (FIG. 1) of the relationship between address 1 and port 120 in address table 134 (FIG. 1) of data plane 126 in member device 112. Thus when data plane 126 receives a packet 150 (FIG. 1) destined for address 1, data plane 126 forwards the packet through port 120. Control plane 124 keeps a copy of address table 134 at the control plane. Block 406 may be followed by block 408.

In block 408, the control plane configures other data plane(s) of other member device(s) with other mapping(s) between the address and other port(s) of the other member device(s) in the service link aggregation group. For example, control plane 124 records a mapping 158 of the relationship between address 1 and port 122 in address table 136 (FIG. 1) of data plane 130 in member device 114. Thus when data plane 130 receives a packet destined for address 1, data plane 130 forwards the packet through port 122. Control plane 124 keeps a copy of address table 136 at the control plane.

As described above, the control plane records a different mapping in each member device's data plane, and each mapping records the relationship between the address and a port of the member device in the service link aggregation group.

When the address is learned from a layer 2 packet, address table 136 is a layer 2 forwarding table and the address includes a source media access control (MAC) address and a virtual local area network (VLAN) identifier. Table 1 shows a layer 2 forwarding table 136 in examples of the present disclosure.

TABLE 1

| MAC address | VLAN ID | Egress Interface |
|---|---|---|
| Address 1 | VLAN 20 | Port 120 |
| Address 2 | VLAN 20 | Port 120 |

When the address is learned from a layer 3 packet, address table 136 is layer 3 forwarding table and the address includes a source Internet Protocol (IP). Table 2 shows a layer 3 forwarding table 136 in examples of the present disclosure.

TABLE 2

| IP Address | Egress Interface |
|---|---|
| Address 1 | Port 120 |
| Address 2 | Port 120 |

Method 400 may end or block 408 may be followed by block 402 to process the next new address.

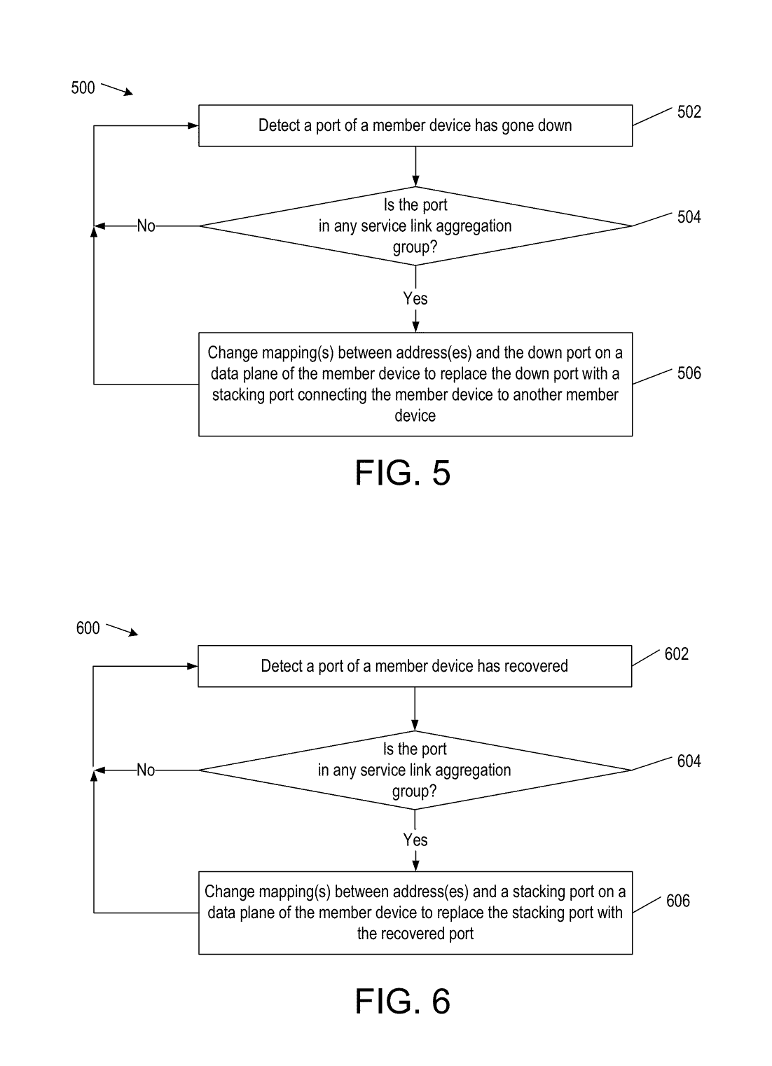

FIG. 5 is a flowchart of a method 500 for a control plane of a member device in logical network device 102 (FIG. 2) to update the data planes of the member devices in logical network device 102 when ports change to the link down state in examples of the present disclosure. Method 500 may be performed by a control plane of a master device in logical network device 102. For example, method 500 may be performed by a processor in the CPU system on the control plane. Method 500 may begin in block 502.

In block 502, the control plane learns a port of a member device has gone down (e.g., changed to the link down state). For example, control plane 124 (FIG. 2) learns port 120 (FIG. 2) has changed to the link down state. Block 502 may be followed by block 504.

In block 504, the control plane determines if the down port is a member of any service link aggregation group. To do so, the control plane searches for the down port in service link aggregation groups. If the control plane finds the down port in a service link aggregation group, block 504 may be followed by block 506. Otherwise method 500 may end or block 504 may be followed by block 502 to process the next new address. For example, when port 120 changes to the link down state, control plane 124 determines if port 120 is a member of any service link aggregation group and finds port 120 to be a member of service link aggregation group 132 (FIG. 2).

In block 506, the control plane changes mapping(s) between address(es) and the down port on the data plane where the down port is located so packets destined for address(es) learned from the port(s) in the service link aggregation group are forwarded through a stacking port from the member device to another member device. The control plane changes the mapping(s) to replace the down port with a stacking port as their egress interface. The control plane may find the mapping(s) based on the address(es) in the service link aggregation group or the down port, or the mapping(s) may identify the service link aggregation group in the address table. As previously described, when the data plane has multiple stacking ports, the control plane may select one of the stacking ports based on a predetermined selection strategy. For example, when port 120 changes to the link down state, control plane 124 updates address table 134 (FIG. 2) in data plane 126 (FIG. 2) by changing mappings 152 and 154 (FIG. 2) to replace down port 120 with a stacking port 142 as their egress interface. Thus when data plane 126 receives a packet 202 (FIG. 2) destined for address 1 or 2, data plane 126 forwards the packet through stacking port 142.

FIG. 6 is a flowchart of a method 600 for a control plane of a member device in logical network device 102 (FIG. 1) to update the data planes of the member devices in logical network device 102 when ports recover to the link up state in examples of the present disclosure. For example, method 600 may be performed by a processor in the CPU system on the control plane. Method 600 may begin in block 602.

In block 602, the control plane learns a port has recovered (e.g., changed to the link up state). For example, control plane 124 (FIG. 1) learns port 120 has recovered to the link up state. Block 602 may be followed by block 604.

In block 604, the control plane determines if the recovered port is a member of any service link aggregation group. If so, block 604 may be followed by block 606. Otherwise method 600 may end or block 604 may be followed by block 602 to process the next port. For example, control plane 124 determines if recovered port 120 is a member of a service link aggregation group and finds recovered port 120 to be a member of service link aggregation group 132.

In block 606, the control plane updates the data plane where the member port is located so packets destined for address(es) learned from the port(s) in the service link aggregation group are forwarded through the recovered port instead of a stacking port. The control plane changes the mapping(s) to replace the stacking port with the recovered port as their egress interface. The control plane may find the mapping(s) based the original copy of address table kept at the control plane. For example, when port 120 recovers to the link up state, control plane 124 updates address table 134 (FIG. 1) in data plane 126 by changing mappings 152 and 154 (FIG. 2) to replace stacking port 142 (FIG. 2) with port 120 as their egress interface.

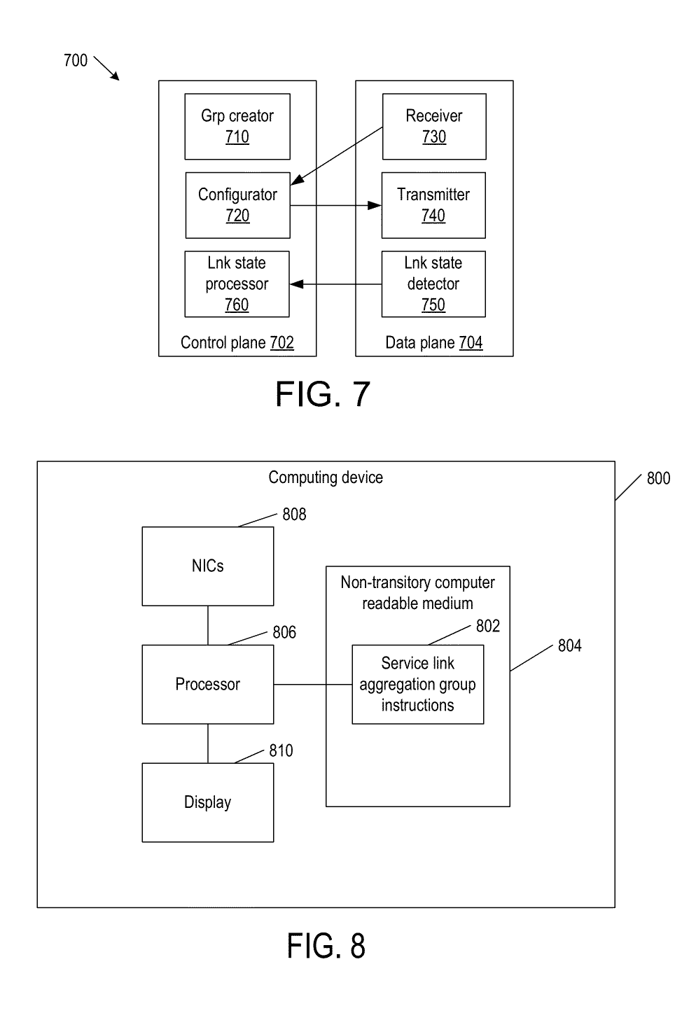

FIG. 7 is a member device 700 that provides service link aggregation groups in a logical network device in examples of the present disclosure. Member device 700 includes a control plane 702 and a data plane 704. Control plane 702 includes a group creator 710 and a configurator 720 while data plane 704 includes a receiver 730. Group creator 710 implements method 300 (FIG. 3) to create service link aggregation groups. Configurator 720 implements method 400 (FIG. 4) to record mappings between ports in a service link aggregation group and addresses learned from the ports. Receiver 730 has ports to receive packets.

Data plane 704 includes a transmitter 740 to transmit packets received by receiver 730.

Data plane 704 includes a link state detector 750 to detect link states of ports on the member device 700, and control plane 702 includes a link state processor 760. Link state detector 750 and other link state detector(s) on other member device(s) detect port states and inform link state processor 760. Link state processor 760 implements method 500 (FIG. 5) to handle down ports, and method 600 (FIG. 6) to handle recovered ports.

FIG. 8 is a block diagram of a computing device 800 for implementing control plane 702 (FIG. 7) in examples of the present disclosure. Service link aggregation groups are implemented with processor executable instructions 802 stored in a non-transitory computer medium 804, such as hard disk drive, a solid state drive, or another nonvolatile computer memory. A processor 806 executes instructions 802 to provide the described features and functionalities, which may be implemented by sending instructions to a network interface 808 or a display 810.

Various other adaptations and combinations of features of the examples disclosed are within the scope of the invention.

What is claimed is:

1. A method for a control plane of a member device in a logical network device to provide link aggregation groups, the method comprising:
creating a link aggregation group at the control plane, wherein the link aggregation group comprises one port from each member device in the logical network device and all ports in the link aggregation group are connected to a same neighbor device; and
when one of the ports in the link aggregation group receives a packet with an unknown address, configuring a data plane of the member device with a mapping between the address and a port of the member device in the link aggregation group.

2. The method of claim 1, further comprising, when the port is down:
changing the mapping to replace the port with a stacking port connecting the member device to another member device.

3. The method of claim 2, further comprising, when the port recovers:
changing the mapping to replace the stacking port with the port.

4. The method of claim 1, further comprising:
adding the port of the member device to the link aggregation group.

5. The method of claim 4, further comprising:
adding other ports of other member devices in the logical network device to the link aggregation group.

6. The method of claim 5, further comprising:
configuring other data planes of the other member devices with other mappings between the address and the other ports of the other member device in the link aggregation group.

7. The method of claim 1, wherein the address comprises (1) a source media access control (MAC) address and a virtual local area network (VLAN) identifier or (2) a source internet protocol (IP) address.

8. A member device to provide link aggregation groups in a logical network device, comprising:
a group creator to create a link aggregation group at a control plane of the member device, wherein the link aggregation group comprises one port from each member device in the logical network device and all ports in the link aggregation group are connected to a same neighbor device;
a configurator to, when one of the ports in the link aggregation group receives a packet with an unknown address, configure a data plane of the member device with a mapping between the address and a port of the member device in the link aggregation group.

9. The member device of claim 8, further comprising:
a link state processor to, when the port is down, change the mapping to replace the port with a stacking port connecting the member device to another member device.

10. The member device of claim 9, wherein the link stage processor is further to, when the port recovers, change the mapping to replace the stacking port with the port.

11. The member device of claim 8, wherein the group creator is further to add the port of the member device to the link aggregation group.

12. The member device of claim 11, wherein the group creator is further to add other ports of other member devices in the logical network device to the link aggregation group.

13. The member device of claim 12, wherein the configurator is further to configure other data planes of the other member devices with other mappings between the address and the other ports of the other member device in the link aggregation group.

14. The member device of claim 8, wherein the address comprises (1) a source media access control (MAC) address and a virtual local area network (VLAN) identifier or (2) a source internet protocol (IP) address.

15. A non-transitory computer readable medium encoded with executable instructions for execution by a processor in a control plane of a member device in a logical network device to:
create a link aggregation group at the control plane;
add one port from each member device in the logical network device to the link aggregation group, wherein all ports in the link aggregation group connect to a same neighbor device;
learn an unknown address associated with a port in the link aggregation group; and
in each device member's data plane, record a different mapping between the address and a local port of the member device in the link aggregation group.
